(19) United States
(12) Patent Application Publication
(10) Pub. No.: US 2022/0097185 A1
(43) Pub. Date: Mar. 31, 2022

(54) MOBILE ASSEMBLY CELL LAYOUT

(71) Applicant: Divergent Technologies, Inc., Los Angeles, CA (US)

(72) Inventors: Lukas Philip CZINGER, Los Angeles, CA (US); Alex James HAMADE, Los Angeles, CA (US)

(21) Appl. No.: 17/487,952

(22) Filed: Sep. 28, 2021

Related U.S. Application Data
(60) Provisional application No. 63/085,986, filed on Sep. 30, 2020.

(51) Int. Cl. B23P 21/00

(52) U.S. Cl. CPC B23P 21/002; B62D 65/02

(57) ABSTRACT

An apparatus for assembling structures is provided. The apparatus includes an assembly robot and a mobile unit coupled to or integrated with the assembly robot. A controller coupled to the assembly robot and the mobile unit can selectively operate the assembly robot and the mobile unit based at least in part on an assembly being produced, such that the controller selectively operates the mobile unit when at least one of the assembly being produced and a sequence of assembly of is altered.

### CROSS-REFERENCE TO RELATED APPLICATIONS

This application claims the benefit of U.S. Provisional Patent Application No. 63/085,986, entitled “MOBILE ASSEMBLY CELL LAYOUT” by Lukas Philip Czinger et al., filed on Sep. 30, 2020, which is expressly incorporated by reference herein in its entirety.

### BACKGROUND

### Field

The present disclosure relates generally to robotic systems and apparatuses, and more particularly, to configurations of assembly cells that include robotic apparatuses.

### Introduction

A vehicle such as an automobile, truck or aircraft is made of a large number of individual structural components joined together to form the body, frame, interior and exterior surfaces, etc. These structural components provide form to the automobile, truck and aircraft, and respond appropriately to the many different types of forces that are generated or that result from various actions like accelerating and braking. These structural components also provide support. Structural components of varying sizes and geometries may be integrated in a vehicle, for example, to provide an interface between panels, extrusions, and/or other structures. Thus, structural components are an integral part of vehicles.

Most structural components must be joined with another part, such as another structural component, in secure, well-designed ways. Modern vehicle factories rely heavily on robotic assembly of structural components. However, robotic assembly of vehicular components requires the use of an assembly line, fixtures, and other similar features. Such features in conventional vehicular assembly are generally statically configured. In automobile factories, for example, each part of the automobile that will be robotically assembled requires a unique fixture that is specific to that part. Additionally, each robot is configured to use a single fixture at a single location. Each robot uses a respective fixture to add one type of part to a semi-finished assembly as the semi-finished assembly moves from robot to robot in according to a fixed sequence.

Sequentially adding parts to an assembly as the assembly moves down the line requires that the assembly remain at the workstation of a robot for an appreciable amount of time, e.g., as each robot adds a respective part at each workstation. Furthermore, only one type of assembly is produced according to a configuration of a line. Given the substantial cost to produce an assembly, configuring a line to produce only one type of assembly for mass production is currently the only economically feasible option.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

A need exists for improvements to modern vehicular assembly. Such improvements may be more economical, both in terms of time and capital. For example, such improvements may allow for production of different vehicles and assemblies using the same robots in a manner that is practical both in terms of time and in investment. The present disclosure provides for more robust and dynamic approaches to vehicular assembly that are different from conventional assembly lines and/or conventional assembly cells that include multiple robots.

In particular, the present disclosure describes various techniques and solutions to configuring manufacturing cells (also called “assembly cells” herein) with robots, where the assembly cells can be reconfigured to remove and/or add robots. Such reconfigurations may be performed to increase efficiency, replace a robot that is malfunctioning, or for other reasons.

Furthermore, different types and configurations of structures may be joined, e.g., through changing the configurations of robots and/or translation of robots in assembly cells or between assembly cells. Thus, the aspects of moving robots between assembly cells, and/or reprogramming robots within assembly cells as described herein, may offer space, time, and/or cost improvements over conventional vehicular manufacturing systems.

An apparatus in accordance with an aspect of the present disclosure comprises an assembly robot, a mobile unit, coupled to the assembly robot, and a controller, coupled to the assembly robot and the mobile unit, wherein the controller selectively operates the assembly robot and the mobile unit based at least in part on an assembly being produced, such that the controller selectively operates the mobile unit when at least one of the assembly being produced and a sequence of assembly of is altered.

A method for reconfiguring an assembly cell in accordance with an aspect of the present disclosure comprises coupling a robot to a mobile unit, arranging the mobile unit in the assembly cell, operating the robot and the mobile unit in the assembly cell based at least in part on an assembly being produced in the assembly cell, and selectively moving the mobile unit within the assembly cell when at least one of the assembly being produced and a sequence of assembly is altered.

A method for reconfiguring an assembly cell in accordance with an aspect of the present disclosure comprises arranging a plurality of robots within the assembly cell, coupling at least one robot in the plurality of robots to a mobile unit, arranging the mobile unit in the assembly cell, operating the plurality of robots and the mobile unit in the assembly cell based at least in part on an assembly being produced in the assembly cell, and selectively moving the mobile unit within the assembly cell when at least one of the assembly being produced and a sequence of assembly is altered.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a perspective view of an assembly system including an assembly cell in accordance with an aspect of the present disclosure.

FIG. 1B illustrates a functional block diagram of a computing system in accordance with an aspect of the present disclosure.

FIGS. 2A-2C illustrate overhead perspective views of assembly systems including an assembly cell, in accordance with an aspect of the present disclosure.

FIGS. 3A-3D illustrate overhead perspective views of assembly systems including an assembly cell, in accordance with an aspect of the present disclosure.

FIG. 4 illustrates a movable robot in accordance with an aspect of the present disclosure.

FIG. 5 illustrates a flow diagram of a manufacturing flow in accordance with an aspect of the present disclosure.

FIG. 6 illustrates a flow diagram of an exemplary process for reconfiguring an assembly cell in accordance with an aspect of the present disclosure.

FIG. 7 illustrates a flow diagram of an exemplary process for reconfiguring an assembly cell in accordance with an aspect of the present disclosure.

### DETAILED DESCRIPTION

The detailed description set forth below in connection with the appended drawings is intended to provide a description of various exemplary embodiments of the concepts disclosed herein and is not intended to represent the only embodiments in which the disclosure may be practiced. The term “exemplary” used in this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, in order to avoid obscuring the various concepts presented throughout this disclosure.

Overview

In an aspect of the present disclosure, mechanical devices, such as robots, may assemble parts and/or structures in an automated and/or semi-automated manner. According to various aspects of an assembly process in accordance with an aspect of the present disclosure, multiple robots may be controlled to join two structures together within an assembly cell. The structures may be, for example, nodes, tubes, extrusions, panels, pieces, parts, components, assemblies or subassemblies (e.g., including at least two previously joined structures) and the like. For instance, a structure or a part may be at least a portion or section associated with a vehicle, such as a vehicle chassis, panel, base piece, body, frame, and/or another vehicle component. A node is a structure that may include one or more interfaces used to connect to other structures (e.g., tubes, panels, etc.). One or more of the structures may be produced using additive manufacturing (AM) (e.g., 3-D printing). Various assembly operations may be performed, potentially repeatedly, so that multiple structures may be joined for assembly of at least a portion of a vehicle (e.g., vehicle chassis, body, panel, etc.).

A first robot may be configured to engage with and retain a first structure to which one or more other structures may be joined during various operations performed in association with assembly of at least a portion of an end product, such as a vehicle. For example, the first structure may be a section of a vehicle chassis, panel, base piece, body, frame, etc., whereas other structures may be other sections of the vehicle chassis, panel, base piece, body, frame, etc.

In an aspect of the present disclosure, the first robot may engage and retain a first structure that is to be joined with a second structure, and the second structure may be engaged and retained by a second robot. Various operations performed with the first structure (e.g., joining the first structure with one or more other structures, which may include two or more previously joined structures) may be performed at least partially within an assembly cell that includes a plurality of robots. Accordingly, at least one of the robots may be directed (e.g., controlled) during manipulation of the first structure in order to function in accordance with a precision commensurate with the joining operation.

The present disclosure provides various different embodiments of at least partially directing one or more robots within an assembly system for assembly operations (including pre- and/or post-assembly operations). It will be appreciated that various embodiments described herein may be practiced together. For example, an embodiment described with respect to one illustration of the present disclosure may be implemented in another embodiment described with respect to another illustration of the present disclosure.

The assembly operations may be performed repeatedly so that multiple structures may be joined for assembly of at least a portion of a vehicle (e.g., vehicle chassis, body, panel, and the like). A first material handling robot may retain (e.g. using an end effector) a first structure that is to be joined with a second structure similarly retained by a second material handling robot. A structural adhesive dispensing robot may apply structural adhesive to a portion of the first structure (such as a groove in the case of a tongue-and-groove joint) retained by the first robot. The first material handling robot may then position the first structure at a joining proximity with respect to the second structure retained by the second material handling robot. A metrology system may implement a move-measure-correct (MMC) procedure to accurately measure, correct, and move the robotic arms of the robots and/or the structures held by the robots into optimal positions at the joining proximity (e.g., using laser scanning and/or tracking).

The positioned structures may then be joined together using the structural adhesive and cured (e.g., over time and/or using heat). However, as the curing rate of the structural adhesive may be relatively long, a quick-cure adhesive robot additionally applies a quick-cure adhesive to the first and/or second structures when the first and second structures are within the joining proximity, and then the quick-cure adhesive robot switches to an end-effector which emits electromagnetic (EM) radiation, such as ultraviolet (UV) radiation, onto the quick-cure adhesive. For example, the quick-cure adhesive robot may apply UV adhesive strips across the surfaces of the first and/or second structures such that the UV adhesive contacts both structures, and then the robot may emit UV radiation onto the applied UV adhesive strips. Upon exposure to the EM radiation, the quick-cure adhesive cures at a faster curing rate than the curing rate of the structural adhesive, thus allowing the first and second structure to be retained in their relative positions so that the robots may quickly attend to other tasks (e.g., retaining and joining other parts) without waiting for the structural adhesive to cure. Once the structural adhesive cures, the first and second structures are bonded with structural integrity.

To provide a more economical approach for robotically assembling a transport structure (e.g., an automobile chassis) without requiring numerous fixtures that are dependent on the chassis design, a fixtureless, non-design specific assembly for structural components may be used, and an assembly cell may be reconfigured to increase the efficiency of the manufacturing process. For example, a robot may be configured to directly hold a structure, e.g., using an end effector of a robotic arm, and to position and join that structure with another structure held by another robot during the assembly process. That same robot may also be moved to another portion of an assembly cell, or to a completely different assembly cell, to increase the efficiency of the manufacturing process.

As described, vehicular assembly may include multiple iterations of discrete sets of operations. For example, two robots may join two structures and, once joined, another robot may apply structural adhesive to the joined structures, and still another robot may apply and cure the quick-cure adhesive. The robots may be relatively agnostic to the structures involved in the assembly operations, e.g., as their engagement and retention of structures may be fixtureless. Thus, an assembly cell in which a set of robots move to accomplish assembly operations is practicable.

Such an assembly cell may be arranged according to a polygon, e.g., rather than an assembly line as with conventional manufacturing processes. For example, an assembly cell of the present disclosure may include sets of robots arranged in a circle, which may be more economical than an assembly line in terms of space and/or cost. Furthermore, with such an arrangement, multiple sets of robots may be configured to operate in parallel, e.g., as opposed to serial operation commensurate with a sequential assembly line.

### Assembly Cell Architecture and Operation

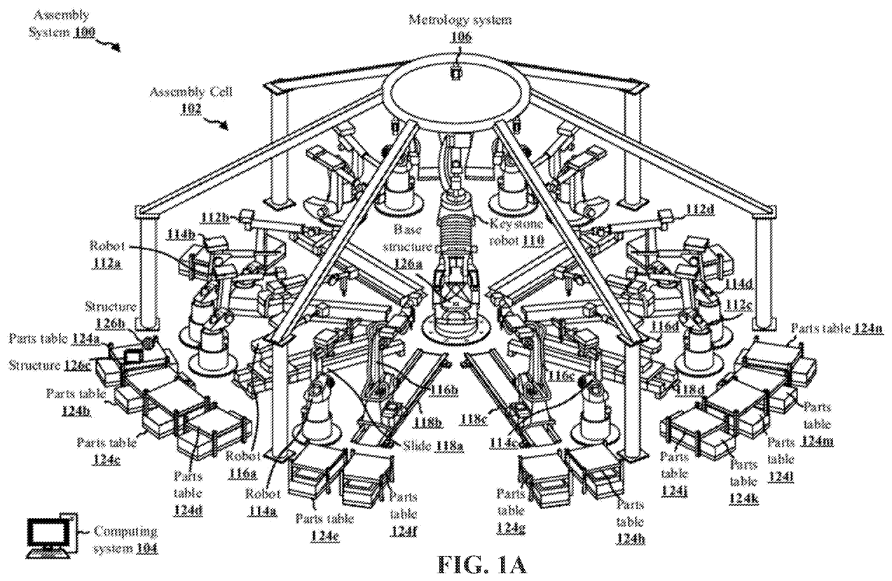

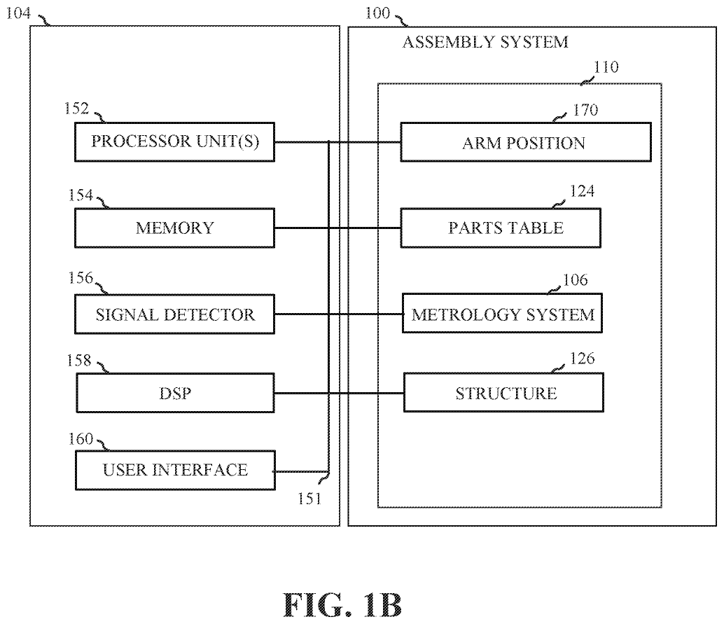

FIG. 1A illustrates a perspective view of an exemplary assembly system 100 in accordance with an aspect of the present disclosure.

Assembly system 100 may be employed in various operations associated with assembly of a vehicle, such as robotic assembly of a node-based vehicle. Assembly system 100 may include one or more elements associated with at least a portion of the assembly of a vehicle without any fixtures. For example, one or more elements of assembly system 100 may be configured for one or more operations in which a first structure is joined with one or more other structures without the use of any fixtures during robotic assembly of a node-based vehicle.

An assembly cell 102 may be configured at the location of assembly system 100. Within assembly cell 102, fixtureless assembly system 100 may include a set of robots. A robot 110 that is positioned relatively at the center of assembly cell 102 may be referred to as a “keystone robot.” In some embodiments, keystone robot 110 may be positioned at an approximate center point of assembly cell 102.

Assembly system 100 may include parts tables 124a-n that can hold structures (e.g., parts) for the robots to access. Parts tables 124a-n may be positioned at a periphery or outside of assembly cell 102. For example, parts tables 124a-n may be radially positioned around approximately the outer boundary of assembly cell 102. In some embodiments, parts tables may be moved using methods such as automated guided vehicles (AGVs).

Each of parts tables 124a-n may hold any number of structures (e.g., from as few as one structure to more than twenty structures), and may be designed so as to provide access to one or more of the structures at different stages of the assembly process. In some embodiments, one or more of parts tables 124a-n may be restocked during the assembly process. For example, new structures may be added to one or more of parts tables 124a-n in anticipation of future assembly operations as some other assembly operations are occurring.

Illustratively, structures 126b-c may be positioned on a first parts table 124a to be picked up by the robots and assembled together. In various embodiments, each of the structures can weigh at least 10 grams (g), 100 g, 500 g, 1 kilograms (kg), 5 kg, 10 kg, or more. In various embodiments, each of the structures can have a volume of at least 10 milliliter (ml), 100 ml, 500 ml, 1000 ml, 5000 ml, 10,000 ml, or more. In various embodiments, one or more of the structures can be an additively manufactured structure, such as a complex node.

Assembly system 100 may also include a computing system 104 to issue commands to the various controllers of the robots of assembly cell 102. In this example, computing system 104 is communicatively connected to the robots through a wireless communication, although wired connections are also possible. Assembly system 100 may also include a metrology system 106 able to accurately measure the positions of the robotic arms of the robots and/or the structures held by the robots. In some embodiments, metrology system 106 may communicate with computing system 104, e.g., to provide data for MMC processes in which computing system 104 may provide instructions to the controllers of the robots. In example assembly system 100, metrology system 106 can be mounted in a central location above assembly cell 102. In various embodiments, a metrology system may be located, for example, near the perimeter of the assembly cell. Multiple metrology systems can be used in various embodiments, and can be located at various locations within or outside the assembly cell.

In contrast to conventional robotic assembly factories, structures can be assembled without fixtures in assembly system 100. For example, structures need not be connected within any fixtures. Instead, at least one of the robots in assembly cell 102 may provide the functionality expected from fixtures. For example, robots may be configured to directly contact (e.g., using an end effector of a robotic arm) structures to be assembled within assembly cell 102 so that those structures may be engaged and retained without any fixtures. Further, at least one of the robots may provide the functionality expected from the positioner and/or fixture table. For example, keystone robot 110 may replace a positioner and/or fixture table in assembly cell 102.

Keystone robot 110 may include a base and a robotic arm. The robotic arm may be configured for movement, which may be directed by a controller communicatively connected with keystone robot 110 (e.g., computer-executable instructions loaded into a processor of the controller). Keystone robot 110 may contact a surface of assembly cell 102 (e.g., a floor of the assembly cell) through the base.

Keystone robot 110 may include and/or be connected with an end effector that is configured to engage and retain a base structure 126a, e.g., a portion of a vehicle or other build piece. An end effector may be a component configured to interface with at least one structure. Examples of the end effectors may include jaws, grippers, pins, or other similar components capable of facilitating fixtureless engagement and retention of a structure by a robot. Base structure 126a may be a section of a vehicle chassis, body, frame, panel, base piece, and the like. For example, base structure 126a may comprise a floor panel. In some embodiments, base structure 126a may be referred to as an “assembly.”

In some embodiments, keystone robot 110 may retain the connection with base structure 126a through an end effector while a set of other structures is connected (either directly or indirectly) to base structure 126a. Keystone robot 110 may be configured to engage and retain base structure 126a without any fixtures. In some embodiments, structures to be retained by at least one of the robots (e.g., base structure 126a) may be additively manufactured or co-printed with one or more features that facilitate engagement and retention of those structures by the at least one of the robots without the use of any fixtures.

For example, a structure may be co-printed or additively manufactured with one or more features that increase the strength of the structure, such as a mesh, honeycomb, and/or lattice arrangement. Such features may stiffen the structure to prevent unintended movement of the structure during the assembly process. In another example, a structure may be co-printed or additively manufactured with one or more features that facilitates engagement and retention of the structure by an end effector, such as protrusion(s) and/or recess(es) suitable to be engaged (e.g., gripped, clamped, held, etc.) by an end effector. The aforementioned features of a structure may be co-printed with the structure and therefore may be of the same material(s) as the structure.

In retaining base structure 126a, keystone robot 110 may position (e.g., move) base structure 126a; that is, the position of base structure 126a may be controlled by keystone robot 110 when retained thereby. Keystone robot 110 may retain the first structure by “holding” or “grasping” base structure 126a, e.g., using an end effector of a robotic arm of keystone robot 110. For example, keystone robot 110 may retain the first structure by causing gripper fingers, jaws, and the like to contact one or more surfaces of the first structure and apply sufficient pressure thereto such that the keystone robot controls the position of base structure 126a. That is, base structure may 126a be prevented from moving freely in space when retained by keystone robot 110, and movement of base structure 126a may be constrained by keystone robot 110. As described above, base structure 126a may include one or more features that facilitates engagement and retention of base structure 126a by keystone robot 110 without the use of any fixtures.

As other structures (including subassemblies, substructures of structures, etc.) are connected to base structure 126a, keystone robot 110 may retain the engagement with base structure 126a through the end effector. The aggregate of base structure 126a and one or more structures connected thereto may be referred to as a structure itself, but may also be referred to as an “assembly” or a “subassembly.” Keystone robot 110 may retain an engagement with an assembly once keystone robot 110 has engaged base structure 126a.

As illustrated, assembly system 100 further includes robots 112a-d, 114a-d, 116a-d positioned in assembly cell 102, in addition to keystone robot 110. Assembly cell 102 may feature a radial architecture, in that robots 112a-d, 114a-d, 116a-d may be positioned in assembly cell 102 around a common point (e.g., keystone robot 110 and/or the center of assembly cell 102). For example, robots 112a-d, 114a-d, 116a-d may be arranged in at least two concentric circles (or other concentric polygons), with a first set of robots 112a-d, 114a-d positioned in a first configuration around a common point (e.g., keystone robot 110) and a second set of robots 116a-d positioned in a second configuration around the common point.

The architecture of assembly cell 102 (e.g., including spacing between robots 112a-d, 114a-d, 116a-d and positions of robots 112a-d, 114a-d, 116a-d) may be based on an average part to be assembled, such as a body-in-white (BIW) vehicle or a vehicle chassis, and/or may be based on the fixtureless assembly process of assembly system 100. For example, the layout of assembly cell 102 may be beneficial and/or may improve over a conventional assembly line in terms of assembly cycle time, cost, performance, robot utilization, and/or flexibility.

Within assembly cell 102, the robots may be variably spaced. Specifically, some robots 116a-d may be configured on a respective one of slides 118a-d, which may allow those robots 116a-d to change position (thereby changing robot spacing). That is, each of robots 116a-d on a respective one of slides 118a-d may move toward or away from keystone robot 110, e.g., allowing multiple different robot interactions for joining and/or adhesion.

Some robots 112a-d, 116a-d in assembly cell 102 may be similar to keystone robot 110 in that each includes a respective end effector configured to engage with structures, such as structures that may be connected with base structure 126a when retained by keystone robot 110. In some embodiments, robots 112a-d, 116a-d may be referred to with “assembly” and/or “material handling.”

In some embodiments, some robots 114a-d of assembly cell 102 may be used to effect a structural connection between structures. Such robots 114a-d may be referred to with “structural adhesive” or “adhesive.” The structural adhesive robots may be similar to keystone robot 110, except a tool may be included at the distal end of the robotic arm that is configured to apply structural adhesive to at least one surface of retained structures, e.g., either before or after the structures are positioned at joining proximities with respect to other structures for joining with the other structures. The joining proximity can be a position that allows a first structure to be joined to a second structure. For example, in various embodiments, the first and second structures may be joined though the application of an adhesive while the structures are within the joining proximity and subsequent curing of the adhesive.

Potentially, the duration for structural adhesives to cure may be relatively long. If this is the case, the robots retaining the joined structures, for example, might have to hold the structures at the joining proximity for an appreciable duration in order for the structures to be joined by the structural adhesive once it finally cures. This would prevent the robots from being used for other tasks, such as continuing to pick up and assemble structures, for a long time while the structural adhesive cures. In order to allow more efficient use of the robots, for example, in various embodiments a quick-cure adhesive may be additionally used to join the structures quickly and retain the structures so that the structural adhesive can cure without requiring both robots to hold the structures in place.

In this regard, some robots 114a-d, 116a-d in assembly cell 102 may be used to facilitate retention of the two or more structures, for example, by using a quick-cure adhesive and/or to cure the quick-cure adhesive. In some embodiments, a quick-cure UV adhesive may be used, and the robots may be referred to with “UV.” The UV robots may be similar to keystone robot 110, except a tool may be included at the distal end of the robotic arm that is configured to apply a quick-cure UV adhesive and/or cure the adhesive, e.g., when one structure is positioned within the joining proximity with respect to another structure. For example, the UV robots may include a respective tool configured to apply UV adhesive and to emit UV light to cure the UV adhesive. In effect, the UV robots may cure an adhesive after the adhesive is applied to one or both structures when the structures are within the joining proximity.

In some embodiments, the quick-cure adhesive applied by a UV robot may provide a partial adhesive bond in that the adhesive may retain the relative positions of structures within a joining proximity until the structural adhesive may be applied and/or cured to permanently join the structures. After the structural adhesive permanently joins the structures, the adhesive providing the partial adhesive bond may be removed (e.g., as with temporary adhesives) or may not be removed (e.g., as with complementary adhesives).

In contrast to various other assembly systems that may include a positioner and/or fixture table, described above, the use of a curable adhesive (e.g., quick-cure adhesive) may provide a partial adhesive bond that provides a way to retain the first and second structures during the joining process without the use of fixtures. The partial adhesive bond may provide one way to replace various fixtures that would otherwise be employed for engagement and retention of structures in an assembly system that, for example, uses a positioner and/or fixture table. Another potential benefit of fixtureless assembly, particularly using a curable adhesive, is improved access to various structures of a structural assembly in comparison with the use of fixtures and/or other part-retention tools, which inherently occlude access to sections of the structures to which they are attached.

Moreover, at least partially replacing fixtures and/or other part-retention tools with curable adhesives may provide a more reliable connection at one or more locations on a structural assembly in need of support—particularly where such locations in need of support are rendered nearly or entirely inaccessible by the fixtures and/or other part-retention tools. In addition, at least partially replacing fixtures and/or other part-retention tools with curable adhesives may provide the ability to add more structures to a structural assembly before application of a (permanent) structural adhesive—particularly where fixtures and/or other part-retention tools would hinder access for joining additional structures.

In various embodiments, some robots 114a-d, 116a-d may be used for multiple different roles. For example, robots 114a-d may perform the roles of a structural adhesive robot and a UV robot. In this regard, each of robots 114a-d may be referred to as a “structural adhesive/UV robot.” Each of structural adhesive/UV robots 114a-d may offer functionality of a structural adhesive robot when configured with a tool to apply structural adhesive, but may offer functionality of a UV robot when configured with a tool to apply and/or cure quick-cure adhesive. Structural adhesive/UV robots 114a-d may be configured to switch between tools and/or reconfigure a tool in order to perform the relevant task during assembly operations.

Similarly, robots 116a-d may perform the roles of a material handling robot and a UV robot. Accordingly, each of robots 116a-d may be referred to as a “material handling/UV robot.” Each of material handling/UV robots 116a-d may provide the functionality of a material handling robot when configured with an end effector for fixtureless retention of a structure, and may also provide the functionality of a UV robot when configured with a tool to apply and/or cure quick-cure adhesive. As with structural adhesive/UV robots 114a-d, material handling/UV robots 116a-d may be configured to switch between tools and/or reconfigure a tool in order to perform different operations at different times.

In assembly system 100, at least one surface of a structure to which adhesive is to be applied may be determined based on gravity and/or other forces that cause loads to be applied on various structures and/or connections of the assembly. Finite element method (FEM) analyses may be used to determine the at least one surface of the structure, as well as one or more discrete areas on the at least one surface, to which the adhesive is to be applied. For example, FEM analyses may indicate one or more connections of a structural assembly that may be unlikely or unable to support sections of the structural assembly disposed about the one or more connections.

In assembling at least a portion of a vehicle in assembly cell 102, one structure may be joined directly to another structure by directing the various robots 112a-d, 114a-d, 116a-d, as described herein. However, additional structures may be indirectly joined to one structure. For example, one structure may be directly joined to another structure through movement(s) of material handling robots 112a-d, structural adhesive/UV robots 114a-d, and material handling/UV robots 116a-d. Thereafter, one structure may be indirectly joined to an additional structure as the additional structure is directly joined to the other structure, for example, through movement(s) that additionally include keystone robot 110. Thus, structures may evolve throughout an assembly process as additional structures are directly or indirectly joined to it.

In some embodiments, robots 112a-d, 114a-d, 116a-d may join two or more structures together, e.g., with a partial, quick-cure adhesive bond, before joining those two or more structures with a structure(s) retained by keystone robot 110. The two or more structures that are joined to one another prior to being joined with base structure 126a may also be a structure, and may further be referred to as a “subassembly.” Accordingly, when a structure forms a portion of a structural subassembly that is connected with base structure 126a through movements of one or more robots 110, 112a-d, 114a-d, 116a-d, a structure of the structural subassembly may be indirectly connected to base structure 126a when the structural subassembly is joined to base structure 126a.

In some embodiments, the structural adhesive may be applied (e.g., deposited in a groove of one of the structures) before two structures are brought within the joining proximity. For example, one of structural adhesive/UV robots 114a-d may include a dispenser for dispensing a structural adhesive, and may apply the structural adhesive prior to the structures being brought within the joining proximity.

In some other embodiments, a structural adhesive may be applied after a structural assembly is fully constructed. For example, the structural adhesive may be applied to one or more joints or other connections between structures. The structural adhesive may be applied at a time after the last adhesive curing is performed. In some embodiments, the structural adhesive may be applied separately from assembly system 100.

After the assembly is complete (e.g., after all of the structures have been joined, retained with a partial adhesive bond, and with structural adhesive having been applied), the structural adhesive may be cured. Upon curing the structural adhesive, the portion of the vehicle may be completed and, therefore, may be suitable for use in the vehicle. For example, the assembly may be a vehicle in the body-in-white (BIW) stage. A completed structural assembly may meet any applicable industry and/or safety standards defined for consumer and/or commercial vehicles. In some embodiments, the adhesive applied to achieve the partial adhesive bond for retaining structures may be removed, for example, after the structural adhesive is cured. In some other embodiments, the adhesive for the partial adhesive bond may be left attached to the structures.

FIG. 1B illustrates a functional block diagram of a computing system in accordance with an aspect of the present disclosure.

In an aspect of the present disclosure, control devices and/or elements, including computer software, may be coupled to assembly system 100 to control one or more components within assembly system 100. Such a device may be a computer 104, which may include one or more components that may assist in the control of assembly system 100. Computer 104 may communicate with an assembly system 100, and/or other systems, via one or more interfaces 151. The computer 104 and/or interface 151 are examples of devices that may be configured to implement the various methods and procedures described herein, that may assist in controlling assembly system 100 and/or other systems.

In an aspect of the present disclosure, computer 104 may comprise at least one processor 152, memory 154, signal detector 156, a digital signal processor (DSP) 158, and one or more user interfaces 160. Computer 104 may include additional components without departing from the scope of the present disclosure.

Processor 152 may assist in the control and/or operation of PBF system 100. The processor 152 may also be referred to as a central processing unit (CPU). Memory 154, which may include both read-only memory (ROM) and random access memory (RAM), may provide instructions and/or data to the processor 152. A portion of the memory 154 may also include non-volatile random access memory (NVRAM). The processor 152 typically performs logical and arithmetic operations based on program instructions stored within the memory 154. The instructions in the memory 154 may be executable (by the processor 152, for example) to implement the methods described herein.

The processor 152 may comprise or be a component of a processing system implemented with one or more processors. The one or more processors may be implemented with any combination of general-purpose microprocessors, microcontrollers, digital signal processors (DSPs), floating point gate arrays (FPGAs), programmable logic devices (PLDs), controllers, state machines, gated logic, discrete hardware components, dedicated hardware finite state machines, or any other suitable entities that can perform calculations or other manipulations of information.

The processor 152 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, RS-274 instructions (G-code), numerical control (NC) programming language, and/or any other suitable format of code). The instructions, when executed by the one or more processors, cause the processing system to perform the various functions described herein.

Signal detector 156 may be used to detect and quantify any level of signals received by the computer 104 for use by the processor 152 and/or other components of the computer 104. The signal detector 156 may detect such signals as robot 110 (or any other robot 112a-d, 114a-d, 116a-d in assembly system 100) arm position 170, parts table 124 location, metrology system 106 inputs, structure 126 position, and/or other signals. DSP 158 may be used in processing signals received by the computer 104. The DSP 158 may be configured to generate instructions and/or packets of instructions for transmission to assembly system 100.

The user interface 160 may comprise a keypad, a pointing device, and/or a display. The user interface 160 may include any element or component that conveys information to a user of the computer 104 and/or receives input from the user.

The various components of the computer 104 may be coupled together by interface 151, which may include, e.g., a bus system. The interface 151 may include a data bus, for example, as well as a power bus, a control signal bus, and a status signal bus in addition to the data bus. Components of the computer 104 may be coupled together or accept or provide inputs to each other using some other mechanism.

Although a number of separate components are illustrated in FIG. 1B, one or more of the components may be combined or commonly implemented. For example, the processor 152 may be used to implement not only the functionality described above with respect to the processor 152, but also to implement the functionality described above with respect to the signal detector 156, the DSP 158, and/or the user interface 160. Further, each of the components illustrated in FIG. 1B may be implemented using a plurality of separate elements.

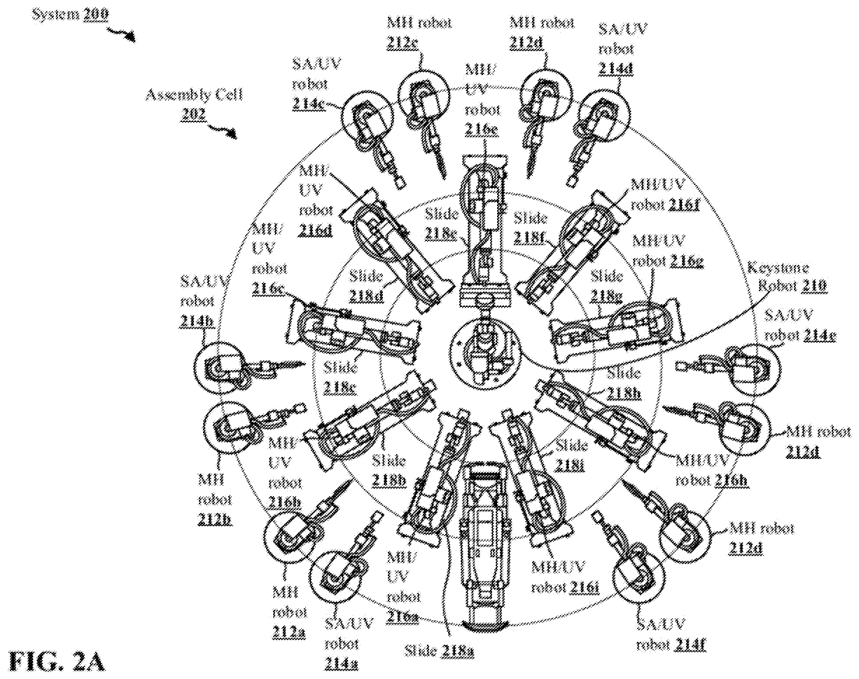

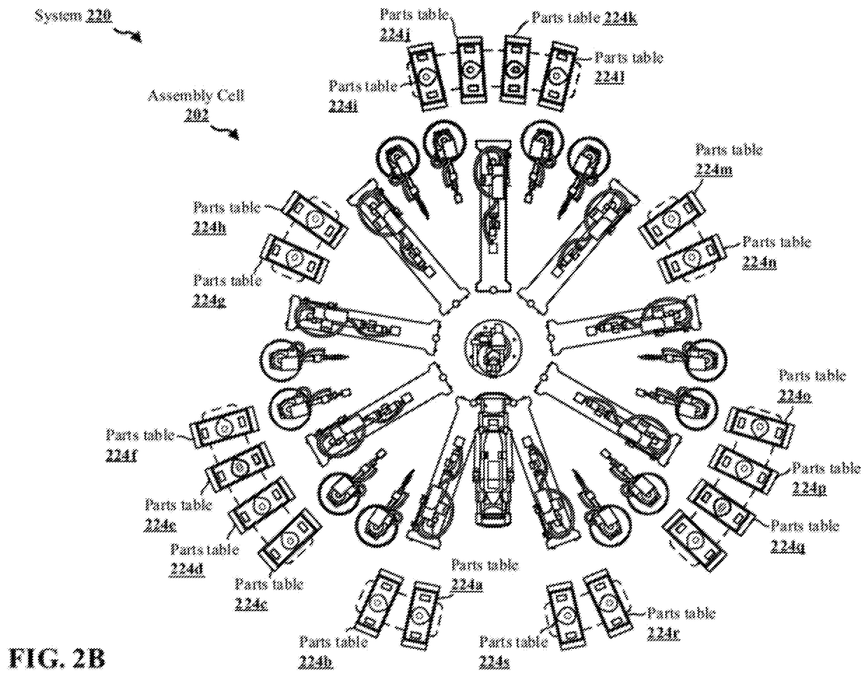

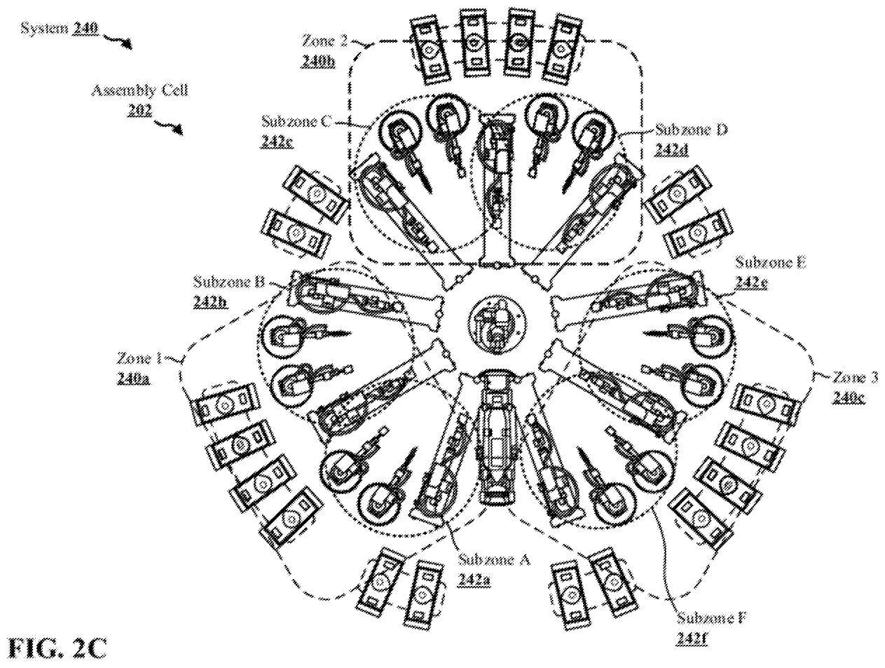

FIG. 2A illustrates an exemplary assembly system 200 including an assembly cell 202, according to various embodiments of the present disclosure. In some embodiments, assembly cell 202 may have dimensions of approximately 15 meters (m) in length by 15 m in width; however, other dimensions are possible without departing from the scope of the present disclosure.

In assembly cell 202, a keystone robot 210 may be positioned at an approximate center point, and may serve as a common point in assembly cell 202. Robots in assembly cell 202 may be positioned in different configurations relative to the common point or keystone robot 110.

For example, a plurality of first robots 212a-f, 214a-f may be positioned around a common point in a first configuration, and a plurality of second robots 216a-i may be positioned around the common point in a second configuration. The second configuration may be closer to the common point than the first configuration. For example, the plurality of first robots 212a-f, 214a-f may be arranged along the perimeter of a first shape, such as a circle or a polygon (e.g., a hexagon), whereas the plurality of second robots 216a-i may be arranged along the perimeter of a second shape, such as a concentric circle or a concentric polygon (e.g., a concentric hexagon).

In some embodiments, some or all robots in the plurality of first robots 212a-f, 214a-f may be fixedly positioned in the first configuration. For example, some of the plurality of first robots 212a-f, 214a-f may be secured or fastened to a floor or other surface of assembly cell 202. In some other embodiments, each of the plurality of second robots 216a-i may be fixedly positioned in the second configuration.

However, in an aspect of the present disclosure, some robots in of the plurality of first robots 212a-f, 214a-f and/or the plurality of second robots 216a-i may be configured to move towards and away from the common point and/or in and out of the assembly cell 202 to allow for reconfiguration of the assembly cell 202.

To allow for the movement of the robots within assembly cell 202 and/or to move the robots outside of assembly cell 202, some of the plurality of second robots 216a-i may be positioned on a respective slide 218a-i or other track, each of which may be controlled to cause a respective one of the plurality of second robots 216a-i to translate towards and away from the common point to interact with a subset of the plurality of first robots 212a-f, 214a-f. Similarly, some of the plurality of first robots 212a-f, 214a-f may be positioned on a slide or track such that the robots can move within assembly cell 202 or be removed from operation within assembly cell 202.

Each of slides 218a-i may have a length of approximately 1.5 m. When positioned on slides 218a-i, the distance between any two of plurality of second robots 216a-i may be approximately at least 1.8 m, which may allow the chassis of a car to move between robots. However, when positioned at the furthest points on slides 218a-i (i.e., closest to the plurality of first robots 212a-f, 214a-f and furthest from keystone robot 210), the distance between any two of plurality of second robots 216a-i may be approximately greater than 1.8 m, which may allow larger objects (e.g., larger vehicle chasses) to clear the robots.

In some embodiments, the plurality of first robots 212a-f, 214a-f may include both material handling (MH) robots 212a-f and structural adhesive (SA)/UV robots 214a-f. In assembly cell 202, the number of material handling robots 212a-f may be equal to the number of structural adhesive/UV robots 214a-f. Potentially, material handling robots 212a-f may alternatingly arranged with structural adhesive/UV robots 214a-f in the first configuration (although not necessarily).

As described above, material handling robots 212a-f may be configured to pick up (e.g., engage and retain) and join structures (e.g., parts). Structural adhesive (SA)/UV robots 214a-f, however, may be configured to apply structural adhesive to at least one surface of at least one structure to be joined with another structure and, additionally, may be configured to apply and cure a quick-cure (e.g., UV) adhesive. For example, each of structural adhesive/UV robots 214a-f may be configured to switch from a tool for dispensing structural adhesive to a tool for curing (e.g., a UV tool) while a proximate one of material handling robots 212a-f and/or a proximate one of material handling/UV robots 216a-i is applying an MMC procedure to join structures during the assembly process.

The plurality of second robots 216a-i may include material handling/UV robots. As with material handling robots 212a-f of the plurality of first robots, each of material handling/UV robots 216a-i may be configured to pick up and join structures (e.g., parts). Material handling/UV robots 216a-i may be further configured to apply and cure a quick-cure (e.g., UV) adhesive to at least one surface of at least one structure to be joined with another structure. In some embodiments, each of material handling/UV robots 216a-i may be configured to switch between a material-handling end effector and a curing (e.g., UV) tool based on structures being joined.

FIG. 2B shows an exemplary assembly system 220 including assembly cell 202, according to various embodiments of the present disclosure. In assembly system 220, a plurality of parts tables 224a-s are included. Each of parts tables 224a-s may be included in assembly cell 202 or may be positioned around a perimeter or outer boundary of assembly cell 202.

Each of parts tables 224a-s may be a respective location at which a set of structures to be used in the assembly process (e.g., joined) is held or arranged. Thus, each of material handling robots 212a-f and each of material handling/UV robots 216a-i may be able to reach structures located on at least one of parts tables 224a-s. For example, each of material handling/UV robots 216a-i may be able to reach structures located on at least one of parts tables 224a-s by varying its position along a respective one of slides 218a-i.

Each of parts tables 224a-s may be modular and/or moveable, e.g., so that structures can be reloaded on the parts tables. As parts tables 224a-s may be radially positioned along the perimeter of assembly cell 202, reloading can occur with minimal or no interruption to operations by the robots. In some embodiments, an automated guided vehicle (AGV) may be configured to move each of parts tables 224a-s away from assembly cell 202 in order to be reloaded with additional structures that will be used as the assembly process progresses. For example, an AGV may transport one of parts tables 224a-s away from assembly cell 202 to a point at which it may be reloaded once it is empty (i.e., once the robots have picked up and removed every structure originally held thereon). Once that one of parts tables 224a-s has been reloaded with structures, an AGV may return it to a respective position relative to assembly cell 202 at which at least one of material handling robots 212a-f and/or at least one of material handling/UV robots 216a-i is able to reach structures located thereon. In some embodiments, a plurality of AGVs may be simultaneously operable so that a plurality of parts tables 224a-s may be simultaneously (or at least contemporaneously) reloaded.

In some embodiments, each of material handling robots 212a-f and each of material handling/UV robots 216a-i may be able to reach structures located on at least two parts tables 224a-s, which may reduce the time commensurate with the assembly process. For example, as further described below, one of material handling robots 212a-f and one of material handling/UV robots 216a-i may pick up and join structures located on one of parts tables 224a-s until that one of parts tables 224a-s is empty. Once that parts table is empty, the one of material handling robots 212a-f and the one of material handling/UV robots 216a-i may pick up and join structures located on a neighboring one of parts tables 224a-s. That one of parts tables 224a-s may be moved by an AGV to be reloaded and returned to its position relative to assembly cell 202 while the robots are picking structures at the neighboring one of parts tables 224a-s. In effect, a continuous assembly process may be achieved in this way, as idle time conventionally commensurate with reloading parts for use may be reduced or eliminated.

FIG. 2C shows an exemplary assembly system 240 including assembly cell 202, according to various embodiments of the present disclosure. According to assembly system 240, assembly cell 202 may be configured as a plurality of zones 240a-c. For example, assembly cell 202 may be divided into three discrete zones; however, more or fewer zones are also possible without departing from the scope of the present disclosure.

According to various embodiments, the plurality of first robots 212a-f, 214a-f and the plurality of second robots 216a-i may be divided within separate zones 240a-c for simultaneously performing various assembly operations, such as joining structures to form subassemblies, which then may be provided to keystone robot 210. While robots within one of zones 240a-c may interact to perform various assembly operations, one or more of the plurality of second robots 216a-i may be configured to translate across separate zones (or one or more of the plurality of first robots 212a-f, 214a-f, if configured on a slide for translation).

In some embodiments, each of zones 240a-c may include at least two subzones. For example, zone 1 240a may include subzone A 242a and subzone B 242b, zone 2 240b may include subzone C 242c and subzone D 242d, and zone 3 may include subzone E 242e and subzone F 242f Each subzone 242a-f may include a respective one of material handling robots 212a-f, a respective one of structural adhesive/UV robots 214a-f, and one of material handling/UV robots 216a-i. In addition, the subzones within zones 240a-c may “share” another one of material handling/UV robots 216a-i. Having some material handling/UV robots 216a-i interact with some other robots across different subzones may improve some assembly operations (e.g., joining and geometry) and assembly time, e.g., as two UV robots may be available for each join.

As described in further detail below, this architecture in which an assembly cell is divided into a plurality (e.g., three) of zones that each include a respective plurality (e.g., two) of subzones allows for parallel and simultaneous assembly operations. Further, some robots are still able to reach, access, and/or interact with other robots to combine subassemblies into larger subassemblies, e.g., until the final subassembly is produced and retained by keystone robot 210.

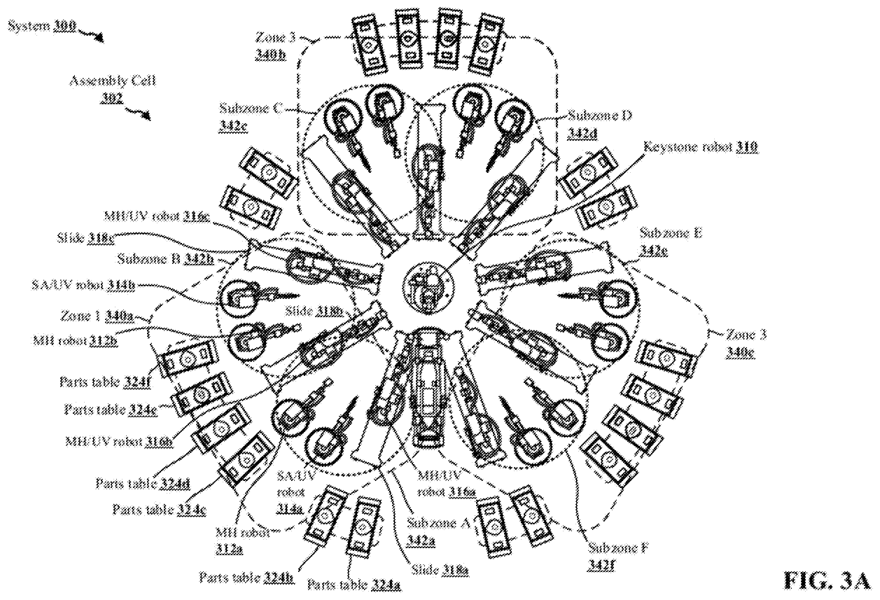

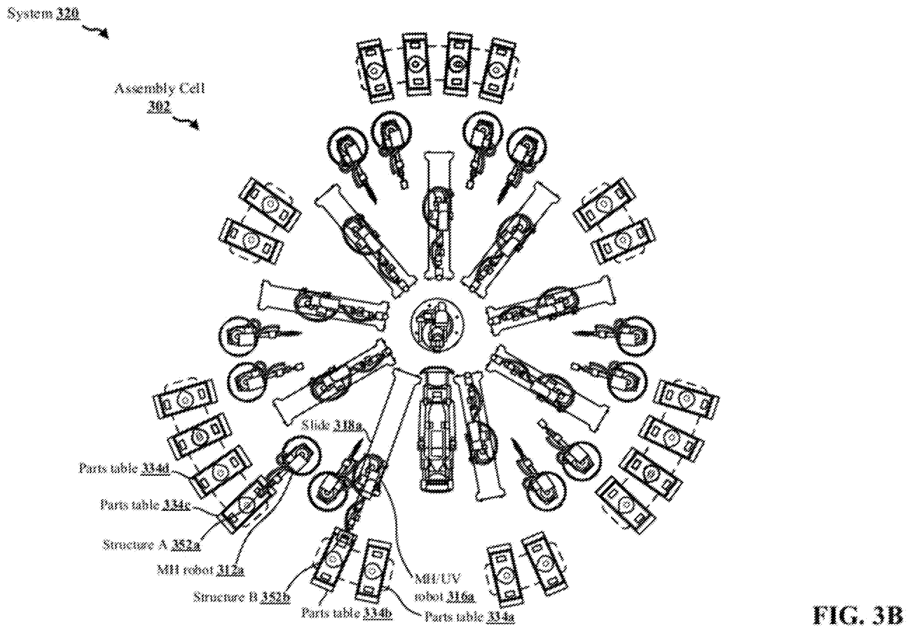

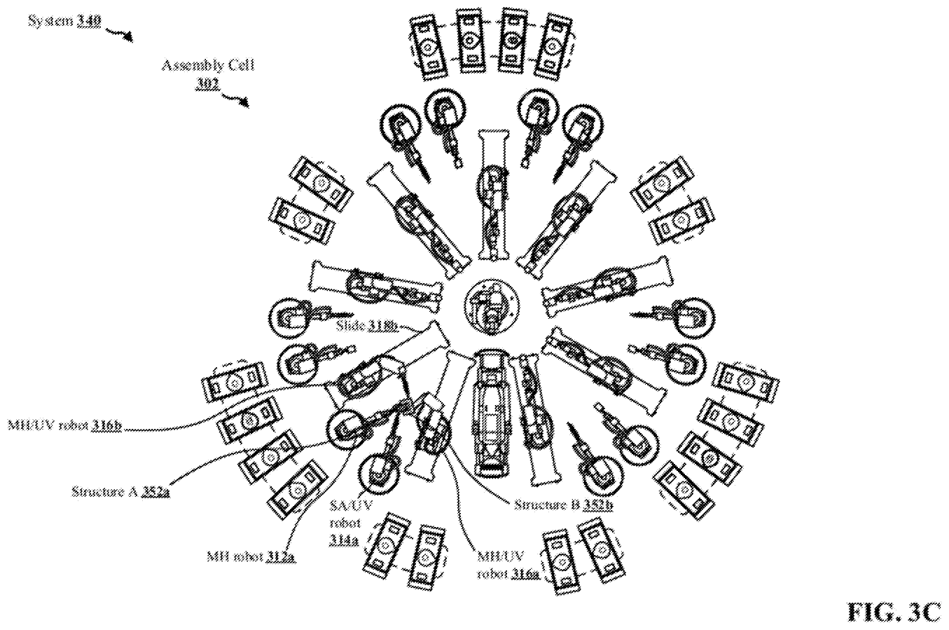

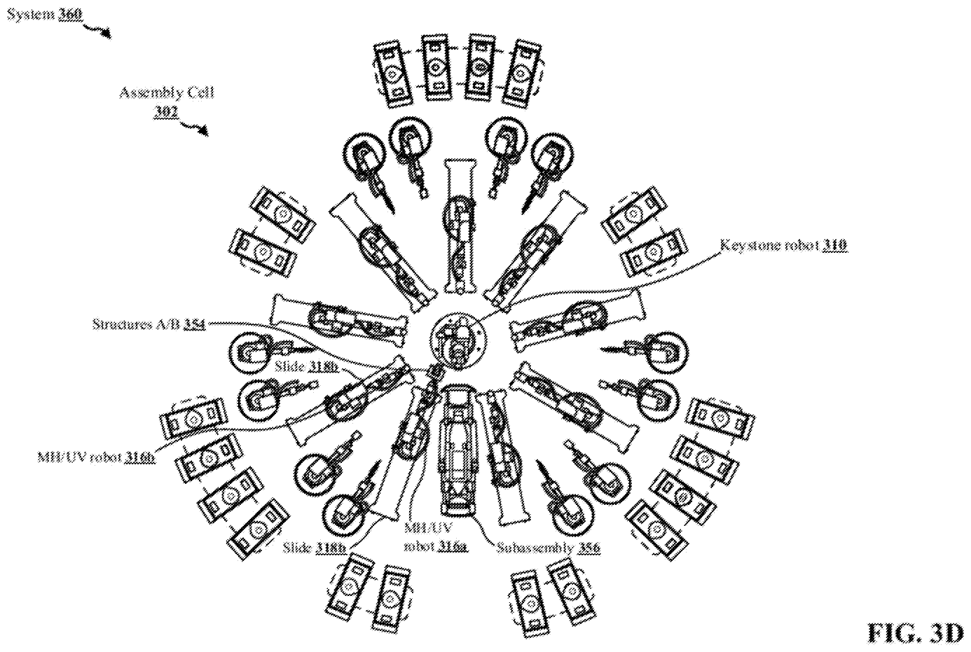

With reference to FIGS. 3A-3D, exemplary assembly operations in assembly systems are illustrated. The assembly systems include robots and parts tables arranged relative to an assembly cell 302, as described according to various embodiments of the present disclosure. In one assembly system 300, assembly cell 302 includes a plurality of first robots positioned around a common point in a first configuration, and a plurality of second robots positioned around the common point in a second configuration that is closer to the common point than the first configuration. The common point may be, for example, a keystone robot 310 that is positioned approximately at the center of assembly cell 302.

The plurality of first robots may include material handling robots structural adhesive/UV robots arranged along the perimeter of a first circle, whereas the plurality of second robots may include material handling/UV robots arranged along the perimeter of a second circle. The plurality of second robots may be configured to translate along a path (e.g., using a slide or other similar mechanism) towards and away from the first circle around which the plurality of first robots is arranged.

Assembly cell 302 may be divided into a plurality (e.g., three) of zones 340a-c, and each of zones 340a-c includes a respective plurality (e.g., two) subzones 342a-f. In some embodiments, each of subzones 342a-f may include two of the plurality of first robots and two of the plurality of second robots; however, one of the two second robots may be shared across subzones 342a-f or even across zones 340a-c. In each of the subzones 342a-f, one of the plurality of second robots may be diagonally opposed to one of the plurality of first robots and another of the plurality of second robots may be diagonally opposed to another of the plurality of first robots.

Illustratively, referring to an assembly system 300 of FIG. 3A, zone 1 340a of assembly cell 302 includes subzone A 342a in which a first material handling/UV robot 316a is diagonally opposed to a first material handling robot 312a that is fixedly positioned in assembly cell 302. Similarly, a second material handling/UV robot 316b is diagonally opposed to a first structural adhesive/UV robot 314a that is fixedly positioned in assembly cell 302.

However, second material handling/UV robot 316b may be shared across subzone A 342a and subzone B 342b of zone 1 340a, and therefore, second material handling/UV robot 316b may also be diagonally opposed to a second structural adhesive/UV robot 314b that is fixedly positioned in subzone B 342b. Also in subzone B 342b, a third material handling robot/UV robot 316c is diagonally opposed to a second material handling robot 312b that is fixedly positioned.

In effect, each of the subzones may include a dedicated material handling robot and a dedicated material handling/UV robot configured to join structures at an approximately diagonal angle, a dedicated structural adhesive robot that is able to function as a UV robot, and a “shared” material handling/UV robot. Such configurations in which robots are diagonally opposed to one another may facilitate two robots capable of UV curing (or otherwise quick curing) joined structures, which may reduce the duration commensurate with quick curing.

For assembly operations in an assembly system 320 shown in FIG. 3B, various material handling robots in each of subzones A-F 342a-f of zones 1-3 340a-c may “pick up” or engage a respective structure from one of the parts tables respectively accessible thereby. Referring to subzone A 342a of zone 1 340a as a representative example, first material handling robot 312a may pick up a structure A 352a from third parts table 334c, which first material handling robot 312a may be configured to access (and empty) before alternating to fourth parts table 334d. For example, first material handling robot 312a may use an end effector to engage and retain structure A 352a.

Similarly, first material handling/UV robot 316a may pick up a structure B 3 52b from second parts table 334b, which first material handling/UV robot 316a may be configured to access (and empty) before alternating to first parts table 334a. First material handling/UV robot 316a may be configured to switch between tools for material handling (e.g., engaging and retaining structures) and quick curing joined structures, and therefore, first material handling/UV robot 316a may be configured to switch to or activate an end effector in order to pick up structure B 352b.

Potentially, first material handling/UV robot 316a may be positioned in assembly cell 302 such that the distance to structure B 352b on second parts table 334b prohibits first material handling/UV robot 316a from engaging structure B 352b. Accordingly, first material handling/UV robot 316a may be configured to change position in assembly cell 302 in order to reduce the distance to second parts table 334b. For example, first material handling/UV robot 316a may use a first slide 318a to traverse a line within assembly cell 302, and first material handling/UV robot 316a may travel on first slide 318a toward the perimeter of assembly cell 302 so the first material handling/UV robot 316a is able to access structures on the parts tables.

In some embodiments, first structural adhesive/UV robot 314a may be configured to switch to or activate a tool for dispensing structural adhesive. First structural adhesive/UV robot 314a may apply structural adhesive to one or more surfaces of at least one of structure A 352a and/or structure B 352b, e.g., once retained by first material handling robot 312a and/or first material handling/UV robot 316a, respectively.

Now with respect to an assembly system 340 shown in FIG. 3C, structure A 352a and structure B 352b may be joined by one or both of the material handling robots. That is, one or both of first material handling robot 312a and/or first material handling/UV robot 316a may bring structure A 352a and/or structure B 352b, respectively, to a joining proximity at which the structures can be joined. In so doing, an MMC procedure may be performed.

For example, one of the material handling robots may move its respectively retained structure into a position at which the two structures can be joined, and then one or more measurements may be determined that are indicative of a difference between the actual position of the structures and the joining proximity at which the structures are able to be joined (e.g., within some acceptable tolerances). The measurements are then used to determine (e.g., calculate) one or more corrective movements of one or both of the material handling robots. The corrective movements are then applied to the appropriate one or both of the material handling robots in order to bring the structures within the joining proximity at which the structures can be joined.

In some embodiments, when the MMC procedure is performed, first structural adhesive/UV robot 314a may switch to or active a quick curing (e.g., UV) tool from the structural adhesive dispensing tool. In switching tools during the period in which structures are joined, the structural adhesive/UV robots may reduce the amount of lost or idle time experienced by the robots in assembly cell 302.

Once structure A 352a and structure B are satisfactorily joined by the material handling robots, first structural adhesive/UV robot 314a may apply UV for quick curing the bond between the structures. Potentially, the “shared” material handling/UV robot may accelerate the quick curing process. For example, second material handling/UV robot 316b may be configured to switch to or activate a quick curing (e.g., UV) tool, and may apply UV to quickly bond structure A 352a and structure B 352b, e.g., contemporaneously with first structural adhesive/UV robot 314a.

In some embodiments, second material handling/UV robot 316b may traverse a line within assembly cell 302 in order to reach a position at which second material handling/UV robot 316b is able to apply UV for quick curing. For example, second material handling/UV robot 316b may use second slide 318b to travel to a point at which it is able to direct its quick curing tool toward the point at which the structures are joined.

Referring to an assembly system 360 shown in FIG. 3D, structure A 352a and structure B 352b may be satisfactorily temporarily bonded. Accordingly, one of the material handling robots may release its respectively retained structure, and the other of the material handling robots may retain the joined structures. For example, first material handling robot 312a may release structure A 352a once the quick curing is completed, and first material handling/UV robot 316a may retain a joined structure A/B 354.

First material handling/UV robot 316a may subsequently bring joined structure A/B 354 to keystone robot 310 to be joined with a subassembly 356. For example, first material handling/UV robot 316a may use first slide 318a to traverse a line toward keystone robot 310 in assembly cell 302. When first material handling/UV robot 316a arrives at an appropriate location, first material handling/UV robot 316a may bring joined structure A/B 354 to a position at which it can be joined with subassembly 356 by keystone robot 310. For example, first material handling/UV robot 316a may position joined structure A/B 354 on a tray or other staging area at keystone robot 310 at which operations for subassembly 356 may be performed.

Potentially, second material handling/UV robot 316b may use second slide 318b to traverse a line toward keystone robot 310 in assembly cell 302. When a suitable position is reached, second material handling/UV robot 316b may facilitate operations for subassembly 356. For example, second material handling/UV robot 316b may apply UV for quick curing when joined structure A/B 354 is joined with subassembly 356 at keystone robot 310.

In various embodiments, other similar operations may be performed by the robots in each subzone of the zones. Thus, structures may be joined and subsequently delivered to keystone robot 310. Subassembly 356 may then be constructed at keystone robot 310 through receiving various joined structures from robots included in each of the subzones of the zones. Once subassembly 356 is completed, material handling/UV robots may use respective slides to traverse lines in assembly cell 302 away from keystone robot 310 in order to increase the space available to remove subassembly 356 from assembly cell 302.

### Layout and Reconfiguration

When designing a layout that is capable of assembling any product/structure, some efficiency (cycle time and utilization) is lost when compared to a layout design based only on one specific structure. Although the assembly cell layouts described with respect to FIGS. 1-3 above illustrate a flexible approach for a wide variety of assemblies, an aspect of the present disclosure contemplates the ability of a more flexible approach to factory resource utilization. In an aspect of the present disclosure, a factory level approach that takes into account factory floor space availability, robot and other equipment availability, robot maintenance and/or repair, parts availability, and other factors can increase the overall factory efficiency.

In an aspect of the present disclosure, the layout of the assembly cell, the interchangeability of robots from one assembly cell to another, and/or the layout of the factory floor is designed to increase efficiency of the overall factory throughput. In such an aspect, the assembly cell throughput may be improved by incorporating the function of layout re-arrangement for specific builds.

In an aspect of the present disclosure, various build elements of the layout, e.g., robots, support equipment, slides, etc., may change their physical locations to form new layout configurations that account for specific structures to be assembled, changes in parts availability, changes in design, etc. to tailor the assembly cell and/or factory throughput for a given towards a specific structure to be assembled.

For example, and not by way of limitation, the structure to be assembled can be a subframe for a car. When the structure to be assembled changes (say from the subframe to a different subframe, or from the subframe to a chassis) the layout may be automatically re-arranged and/or reconfigured to be more efficient for that specific structure. Sequence planning and layout planning software may be used to determine, for example, the ideal layout for a given structure, and can also be used to compare various layouts to determine which layout(s) may be most efficient given the resources available.

This layout would be communicated to the hardware, e.g., robots and support equipment, on the factory floor and the hardware would reconfigure to this specific layout. This process could also be used live to automatically re-arrange/reconfigure if a robot or piece of equipment faulted or was no longer operational—the overall factory/layout planning software would receive this information and solve for the best layout given the new constraints. Over time the assembly factory floor would simply be a pool of assembly resources (robots, adhesive equipment, and other tools that are a part of the Divergent assembly process), these resources would be automatically reconfigured based on, for example, the ideal layout for each specific structure being assembled and the optimal throughput for each structure. For example, if a factory was currently assembling 5 structures, but wanted to decrease the cycle time of structure 1 and increase the cycle time of structure 3 (i.e. make more of 1 and less of 3) the solver would solve for the layouts that achieved these desired changes in rate. This could translate to zero/low cost adaptation to market demand.

By modeling the factory in such a manner, in an aspect of the present disclosure a factory may be operated as a factory as a service (FaaS) infrastructure. In such an aspect, pools of assembly resources can be used with improved efficiency; design teams may be able to submit a designed structure and desired volume/rate to a centralized manufacturing base, and the manufacturing base could produce parts and/or assemble the structure for a fee.

In an aspect of the present disclosure, planning software may be used by the manufacturer to re-configure/optimize factory and/or assembly cell layouts to meet desired rates and priorities. In such an aspect, such an approach separates the design element from the manufacturing and assembly elements, thereby likely increasing entry of teams/persons into the design side as they would no longer have to invest in manufacturing and assembly.

### Enabling Reconfiguration of Factory Floor/Assembly Cell

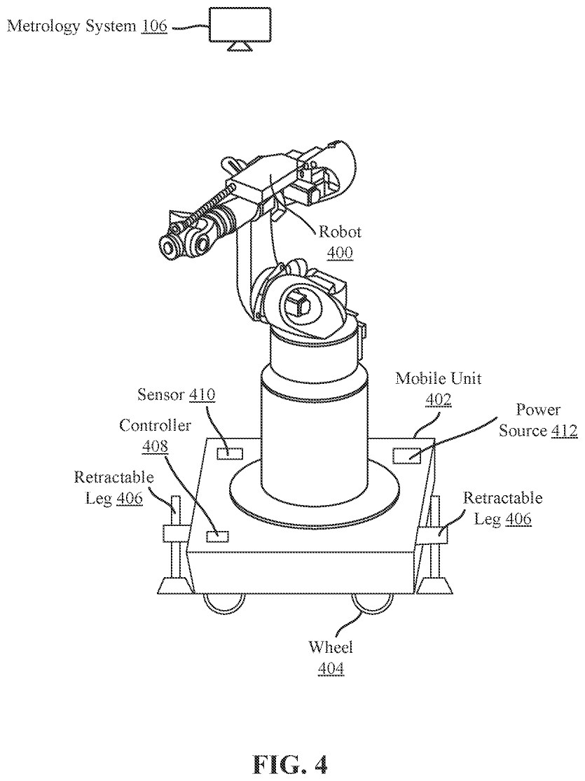

FIG. 4 illustrates a movable robot in accordance with an aspect of the present disclosure.

FIG. 4 illustrates a robot 400, coupled to an mobile unit 402. In various embodiments, the mobile aspect (e.g., the equipment that moves the robot, stabilizes the robot in position, etc.) may be integrated into the robot itself, such as built-in wheels, retractable legs, etc. In various embodiments, the mobile aspect may be detachably attached to the robot (e.g., a mobile platform that the robot can be positioned on and bolted to). Mobile unit 402 may comprise, inter alia, one or more wheels 404, one or more retractable legs 406, one or more controllers 408, one or more sensors 410, and power source 412. Robot 400 may be one or more of robots 110, 112, 114, 116, 210, 212, 214, 216, 310, 312, 314, and 316 as described with respect to FIGS. 1-3.

In an aspect of the present disclosure, some, most, or all assembly hardware can be mobile/have the ability to move in order to achieve re-configurable assembly layouts. The time to reconfigure a given layout to another layout may be compared to the amount of downtime expended to achieve a new layout to determine if rearrangement/reconfiguring the layout would improve factory/cell efficiency.

In an aspect of the present disclosure, a pool of resources, such as robots 400, equipment, etc., can be placed on (or, e.g., integrated with) mobile units 402. The mobile units 402 can be controlled, via computing system 104 and controller 408 to maneuver the robots 400, equipment, etc. from one location to another on the factory floor. By having a database of the various equipment available, as well as monitoring the equipment that is being used, parts needed, parts inventory, etc., the factory processes can be controlled to increase the output of the factory rather than dedicating or semi-dedicating a given cell or robot to assembling a specific part.

In an aspect of the present disclosure, some conventional processes such as welding may be implemented in various embodiments. Further, although cell based architectures are discussed herein, assembly line architectures, either alone or in combination with cell-based manufacturing architectures, may benefit from various aspects of the present disclosures.

Mobile unit 402 may be a slide (as discussed with respect to FIGS. 1-3), may be an automated guide vehicle that runs on tracks or is completely free to move about the factory floor, etc. Wheels 404 may be wheels that allow mobile unit 402 to run on tracks on the factory floor, may be wheels that allow for two dimensional freedom of movement (x and y) for mobile unit 402, etc.

Retractable legs 406 may be provided on mobile unit 402 to provide stability for mobile unit 402 once mobile unit 402 has reached a desired position on the factory floor. Such position may be determined by sensors 410 that are monitored by metrology system 106, or may be determined by other sensors 410 that read positioning markers on the factory floor. Positioning may be determined by relative positioning between one robot 400 and another robot 400 via sensors 410, or by other methods, without departing from the scope of the present disclosure.

Controller 408 may be similar to computing system 104 as described with respect to FIG. 1B. Controller 408 may receive information from various sensors and make decisions based on the information, such as deciding when the robots are in the correct positions and beginning an assembly operation.

Power for the robots 400 and/or mobile units 402 may be supplied using power source 412. In an aspect of the present disclosure, power source 412 may be a battery, a generator, an alternative fuel generator using methanol or other alternative fuel, a power cable connected to building power, an inductive system that is charged through inductive elements embedded in the factory floor, or a combination of these or other power sources. For example, individual inductive elements could be arranged in an array in the floor. The size of the inductive elements may be, e.g., 1 square meter, 1 square foot, etc. Inductive elements in the mobile units 402 can receive electrical power from the inductive elements in the floor, and can power the mobile unit 402 and robot 400, or charge a battery storage in mobile unit 402 to power mobile unit 402 and/or robot 400. In various embodiments, power cables may be mounted overhead on a festoon/grid and motion of mobile unit 402 can be kept within a certain boundary. In another aspect of the present disclosure, battery storage can be provided on board mobile unit 402 that will last for a certain amount of time, and power can be provided from building power once mobile unit 402 reaches a desired location.

In an aspect of the present disclosure, robots 400 may be mounted on mobile units 402 (e.g., automated guided vehicles (AGVs) or similar). The mobile units 402 may be programmed, via controller 408, to follow motion paths during reconfiguration of the cell/factory floor. In an aspect of the present disclosure, mobile units 402 may be guided between positions by sensing features such as magnetic tape or colored flooring.

In an aspect of the present disclosure, each robot 400 mounted to a mobile unit 402 can change position/location in a relatively short period of time. Such a change in position may be triggered by an event on the factory floor, e.g., robot malfunction, change in structure build, etc. The change in position may be controlled by software and sent to one or more robots 400/mobile units 402 via hardwiring or via wireless (Wi-Fi) networks

In an aspect of the present disclosure, mobile unit 402 may include one or more rigid structures, such as retractable legs 406 legs that can be retracted while the mobile unit 402 is being moved. The rigid structures/retractable legs 406 can be deployed to support the mobile unit 402 once the mobile unit 402 reaches its final position, such that the retractable legs 406 support the mobile unit 402. In an aspect of the present disclosure, retractable legs may be controlled by controller 408 and/or computing system 104. In another aspect of the present disclosure, retractable legs may lift wheels 404 off of the factory floor to provide increased stability to robot 400 on mobile unit 402, as well as possibly providing electrical grounding for mobile unit 402. Retractable legs 406 can be pneumatically powered, electrically driven, etc., between extended positions and the retracted positions.

In an aspect of the present disclosure, robots 400 that perform specific functions may be coupled to mobile units 402 that carry tooling/equipment for that function. For example, and not by way of limitation, an adhesive robot may carry a tool rack with the adhesive end effector as well as the actual adhesive meter and supply system, robots that perform UV light cure would carry the UV light end effector hardware, etc.

Positioning of mobile unit 402 (and thus the position of robot 400) may be determined using a laser radar/metrology system, using metrology system 106 and/or sensors 410. In such an aspect of the present disclosure, various artifacts on the factory floor, e.g., magnetic tape, position marks, etc., may be used as references such that mobile unit 402 may measure location and establish a base frame.

In another aspect of the present disclosure, the position/orientation of the mobile unit 402 and robot 400 may be determined through a detection system embedded in the factory floor. For example, the inductive elements of the inductive power system may be used for position detection by transmitting a detection signal through the elements, thus using the inductive elements as detection sensors. The detection signal may detect, for example, an edge, corner, or other portion of a mobile unit 402. The detection system may interpolate detection signals from multiple sensors 410 to increase the position/orientation detection accuracy. In such aspects, the position/orientation detection may also be an input to the induction power system, such that the induction system supplies electrical power only to the inductive elements that the mobile unit 402 is positioned over. Mobile unit 402 may also have a unique identifier, e.g., a radio frequency (RF) tag, which may aid in identification of location of a given mobile unit 402, positioning of mobile unit 402, etc.

### Cell Reconfiguring

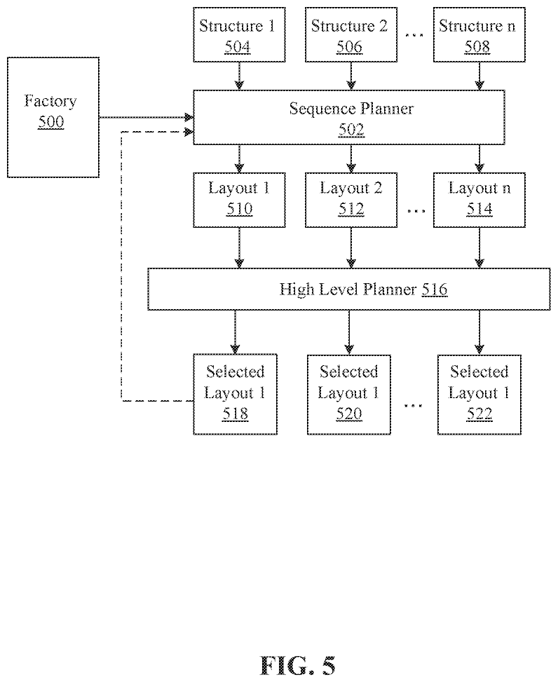

FIG. 5 illustrates a flow diagram of a manufacturing flow in accordance with an aspect of the present disclosure.

Factory 500 is illustrated as an input to sequence planner 502, which, for a given assembly to be performed, may have structure 1 504, structure 2 506, and structure n 508. Although three structures are shown in FIG. 5, a larger or smaller number of structures may be included in the flow diagram without departing from the scope of the present disclosure.

Factory 500 inputs to the sequence planner include, inter alia, the floor space available in a given factory, the robots available, parts carts available, adhesive equipment, and/or any other resources that may be used during assembly of a given structure, sub

Structures 504-508 may be various parts of an assembly, e.g., subframe, chassis, or may be subcomponents of a larger assembly.

Sequence planner 502 may be a software program that generates instructions for a sequence of assembly for each of the structures 504-508, as well as a layout for the assembly cells used to assemble each of the structures 504-508. Sequence planner 502 uses inputs from factory 500, e.g., available resources, and applies the available resources to each of the structures 504-508 to provide sequences and layouts for each of the structures 504-508. For structure 1 504, sequence planner 502 may provide one or more outputs for sequencing and assembly cell layout, illustrated as layout 1 510. Similarly for structure 2 506, sequence planner 502 may provide one or more outputs for sequencing and assembly cell layout, illustrated as layout 2 512, and for structure n 508, sequence planner 502 may provide one or more outputs for sequencing and assembly cell layout, illustrated as layout n 514.

Each of layouts 512-514 may be improved and/or optimized for each of the structures 504-506, however, the overall “best” use of factory 500 resources for improved throughput of the factory 500 may not be determined by sequence planner 502. As such, the layouts 512-514 are then input into high level planner 516, which compares the various layouts 510-514 and determines a “best” or “optimal” layout and/or sequence for each of the structures 504-508, given the constraints of available resources, parts, etc. supplied as inputs by factory 500 to sequence planner. The improved throughput for factory 500 may be determined by high level planner 516, which then selects a layout and/or readjusts the layouts for each structure 504-508 as selected layouts for use in factory 500.

For structure 1 504, high level planner 516 then provides a selected output for sequencing and assembly cell layout, illustrated as selected layout 1 518. Similarly for structure 2 506, high level planner 516 provides a selected output for sequencing and assembly cell layout, illustrated as selected layout 2 520, and for structure n 508, high level planner 516 provides a selected output for sequencing and assembly cell layout, illustrated as selected layout n 522.

Although “best” and “optimal” are used herein, such descriptions are used to describe improvements of the overall throughput for each layout 510-514 and each selected layout 518-522.

In an aspect of the present disclosure, the sequence planner 502 and the high level planner 516 may solve for the optimal layout per structure 504-508 and “balance” the portfolio of structures so that each is being produced at an improved rate for factory 500 output. In such an aspect, this may mean using sub-optimal layouts and/or sequencing for some structures to allow for resources to be used on structures that require longer times.

As can be seen, a constraint on selected layouts 518-520 may be the total “pool” of resources available at factory 500 to balance the selected layouts 518-520. other constraints may include the assembly sequencing based on the number of resources (robots, adhesive equipment etc.), floor space, general rules (spacing requirements for safety, overlaps, boundaries, etc.). High level planner 516 may solve for both the optimal assembly sequence and the optimal assembly layout, or may be weighted towards assembly or layout based on desired cycle times across the entire production portfolio, i.e., across multiple different structures 504-508 to be assembled.

In an aspect of the present disclosure, a given resource in factory 500 may be unavailable, e.g., a robot is malfunctioning, needs repair, parts for a given structure are not available, etc. Rather than have a given assembly cell in factory 500 be non-operational, sequence planner 502 and high level planner 516 may be provided with new inputs, e.g., the current selected layouts 518-522 (shown as a dashed line in FIG. 5), and the lack of various resources, to determine if and how the factory 500 should redistribute the available resources. In such an aspect, some resources may be moved from, e.g., selected layout 518 to selected layout 522, to continue production as best as possible from factory 500.

### Flow Diagrams

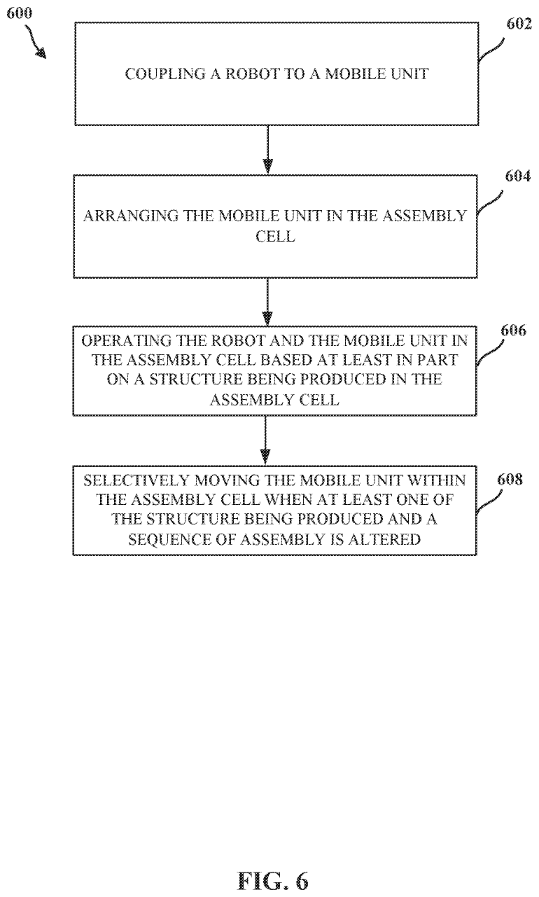

FIG. 6 illustrates a flow diagram of an exemplary process for reconfiguring an assembly cell in accordance with an aspect of the present disclosure.

In an aspect, block 602 includes coupling a robot to a mobile unit. For example, block 602 may include attaching a robot 400 to a mobile unit 402 as described in FIG. 4. In various embodiments, this action (i.e., coupling a robot to a mobile unit) need not be part of the method, rather, it may be performed independently of the method. For example, the method can begin with 604 using pre-created mobile robots (e.g., robots that are built with integrated mobility equipment, robots that have already been attached to mobile units, etc.).

In an aspect, block 604 includes arranging the mobile unit in the assembly cell. For example, block 604 may include arranging mobile unit 402 in assembly cell 100.

In an aspect, block 606 includes operating the robot and the mobile unit in the assembly cell based at least in part on an assembly being produced in the assembly cell. For example, block 606 may include operating robot 400 in assembly cell 100 to assemble a structure.

In an aspect, block 608 includes selectively moving the mobile unit within the assembly cell (or moving the mobile unit outside the assembly cell, e.g., to another assembly cell) when at least one of the assembly being produced and a sequence of assembly is altered. For example, block 608 may include moving the mobile unit 402 based on the manufacturing flow described with respect to FIG. 5.

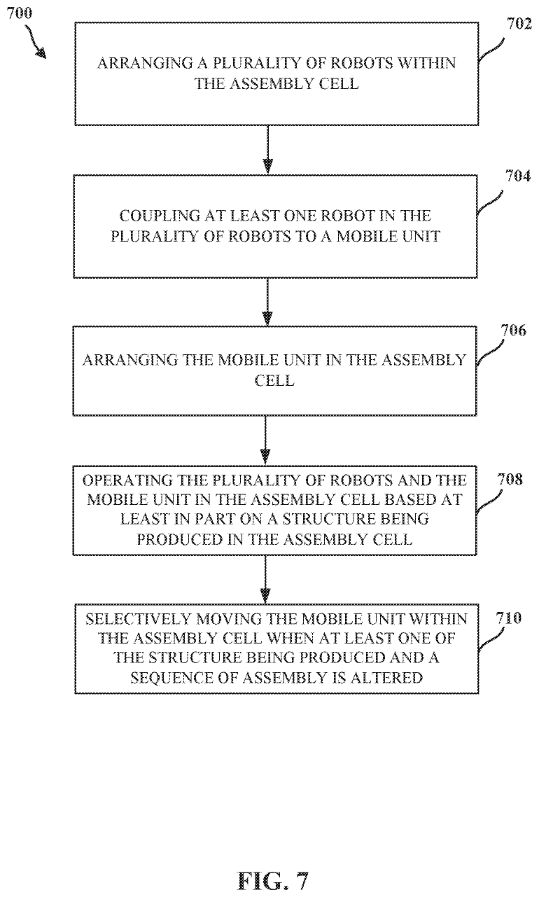

FIG. 7 illustrates a flow diagram of an exemplary process for reconfiguring an assembly cell in accordance with an aspect of the present disclosure.

In an aspect, block 702 includes arranging a plurality of robots within the assembly cell. For example, block 702 may include arranging a plurality of robots as described with respect to FIG. 5.

In an aspect, block 704 includes coupling at least one robot in the plurality of robots to a mobile unit. For example, block 704 may include coupling robot 400 to mobile unit 402 as described with respect to FIG. 4.

In an aspect, block 706 includes arranging the mobile unit in the assembly cell. For example, block 706 may include arranging mobile unit 402 in assembly cell 100.

In an aspect, block 708 includes operating the plurality of robots and the mobile unit in the assembly cell based at least in part on an assembly being produced in the assembly cell. For example, block 708 may include operating the robots and the mobile unit as described with respect to FIG. 1.

In an aspect, block 710 includes selectively moving the mobile unit within the assembly cell when at least one of the assembly being produced and a sequence of assembly is altered. For example, block 710 may include operating the robots and the mobile unit as described with respect to FIG. 5.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” All structural and functional equivalents to the elements of the exemplary embodiments described throughout this disclosure that are known or later come to be known to those of ordinary skill in the art are intended to be encompassed by the claims.

The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims.

Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. An apparatus, comprising:
an assembly robot;
a mobile unit, coupled to the assembly robot; and
a controller, coupled to the assembly robot and the mobile unit, wherein the controller selectively operates the assembly robot and the mobile unit based at least in part on an assembly being produced, such that the controller selectively operates the mobile unit when at least one of the assembly being produced and a sequence of assembly of is altered.

2. The apparatus of claim 1, wherein the controller selectively operates the mobile unit based at least in part on a time of usage of the assembly robot coupled to the mobile unit.

3. The apparatus of claim 1, wherein the controller selectively operates the mobile unit based at least in part on a cycle time associated with an assembly cell that includes the assembly robot coupled to the mobile unit.

4. The apparatus of claim 1, wherein the mobile unit further comprises a stabilizing apparatus to secure the mobile unit at a location within an assembly cell.

5. The apparatus of claim 4, further comprising a locator, coupled at least to the mobile unit, wherein the locator positions the mobile unit within the assembly cell.

6. The apparatus of claim 5, wherein the locator is further coupled to the assembly robot and changes at least one operation of the assembly robot when a position of the mobile unit is changed within the assembly cell.

7. A method for reconfiguring an assembly cell, comprising:
coupling a robot to a mobile unit;
arranging the mobile unit in the assembly cell;
operating the robot and the mobile unit in the assembly cell based at least in part on an assembly being produced in the assembly cell; and
selectively moving the mobile unit within the assembly cell when at least one of the assembly being produced and a sequence of assembly is altered.

8. The method of claim 7, wherein the mobile unit is selectively moved based at least in part on a time of usage of the robot coupled to the mobile unit.

9. The method of claim 7, wherein the mobile unit is selectively moved based at least in part on based at least in part on a cycle time associated with the assembly cell.

10. The method of claim 7, further comprising selectively stabilizing the mobile unit when the mobile unit is at a desired location within the assembly cell.

11. The method of claim 7, further comprising positioning the mobile unit within the assembly cell based at least in part on a relative position of the mobile unit to at least one indicator within the assembly cell.

12. The method of claim 7, wherein an operation of the robot coupled to the mobile unit is altered when the mobile unit is proximate the at least one indicator.

13. A method for reconfiguring an assembly cell, comprising:
arranging a plurality of robots within the assembly cell;
coupling at least one robot in the plurality of robots to a mobile unit;
arranging the mobile unit in the assembly cell;
operating the plurality of robots and the mobile unit in the assembly cell based at least in part on an assembly being produced in the assembly cell; and
selectively moving the mobile unit within the assembly cell when at least one of the assembly being produced and a sequence of assembly is altered.

14. The method of claim 13, wherein the mobile unit is selectively moved based at least in part on a time of usage of the robot coupled to the mobile unit.

15. The method of claim 13, wherein the mobile unit is selectively moved based at least in part on based at least in part on a cycle time associated with the assembly cell.

16. The method of claim 13, further comprising selectively stabilizing the mobile unit when the mobile unit is at a desired location within the assembly cell.

17. The method of claim 13, further comprising positioning the mobile unit within the assembly cell based at least in part on a relative position of the mobile unit to at least one indicator within the assembly cell.

18. The method of claim 13, wherein an operation of the robot coupled to the mobile unit is altered when the mobile unit is proximate the at least one indicator.
